(19) United States
(12) Patent Application Publication
(10) Pub. No.: US 2026/0158791 A1
(43) Pub. Date: Jun. 11, 2026

(54) LIQUID EJECTION APPARATUS

(71) Applicant: SEIKO EPSON CORPORATION, TOKYO (JP)

(72) Inventor: Kazutoshi FUJISHIMA, AZUMINO-SHI (JP)

(21) Appl. No.: 19/411,664

(22) Filed: Dec. 8, 2025

(30) Foreign Application Priority Data
Dec. 10, 2024 (JP) 2024-215152

(51) Int. Cl. B41J 2/17; B41J 2/175

(52) U.S. Cl. CPC B41J 2/1707; B41J 2/17523; B41J 2/17596

(57) ABSTRACT

A liquid ejection apparatus includes a liquid reservoir configured to store a liquid, a liquid ejection unit configured to eject the liquid, a liquid flow path configured to supply the liquid from the liquid reservoir to the liquid ejection unit, and a deformation section including a gas container configured to change a cross-sectional shape of the liquid flow path.

The present application is based on, and claims priority from JP Application Serial Number 2024-215152, filed Dec. 10, 2024, the disclosure of which is hereby incorporated by reference herein in its entirety.

### BACKGROUND

### 1. Technical Field

The present disclosure relates to a liquid ejection apparatus.

### 2. Related Art

JP-A-2014-184604 discloses a liquid ejection apparatus including a circulation path configured with a container that stores a liquid, a flow path that delivers the liquid in the container to a head, the head that ejects the liquid delivered from the container, and a flow path that delivers the liquid in the head to the container. A stirring unit is disposed in the container. When using a liquid that generates a sediment when not in use, the liquid ejection apparatus suppresses the sedimentation of the sediment by stirring the liquid with the stirring unit.

JP-A-2014-184604 is an example of the related art.

In the liquid ejection apparatus described in JP-A-2014-184604, there is a possibility that the sedimentation of the liquid occurs in a flow path outside the container in which the liquid is stirred.

### SUMMARY

A liquid ejection apparatus includes a liquid reservoir configured to store a liquid, a liquid ejection unit configured to eject the liquid, a liquid flow path configured to supply the liquid from the liquid reservoir to the liquid ejection unit, and a deformation section including a gas container configured to change a cross-sectional shape of the liquid flow path.

### BRIEF DESCRIPTION OF THE DRAWINGS

FIG. 1 is a schematic diagram illustrating a configuration of a liquid ejection apparatus.

FIG. 2 is a schematic diagram illustrating a configuration of a liquid supply section and a deformation section.

FIG. 3A is a diagram schematically showing a change in cross-sectional shape of a liquid flow path.

FIG. 3B is a diagram schematically showing the change in cross-sectional shape of the liquid flow path.

FIG. 4 is a diagram showing a combination of pressure in a gas container.

FIG. 5A is a diagram schematically showing a change in cross-sectional shape of a liquid flow path in a second embodiment.

FIG. 5B is a diagram schematically showing the change in cross-sectional shape of the liquid flow path in the second embodiment.

FIG. 6 is a diagram showing a combination of pressure in a gas container in the second embodiment.

FIG. 7A is a diagram schematically showing a change in cross-sectional shape of a liquid flow path in a third embodiment.

FIG. 7B is a diagram schematically showing the change in cross-sectional shape of the liquid flow path in the third embodiment.

FIG. 7C is a diagram schematically showing the change in cross-sectional shape of the liquid flow path in the third embodiment.

FIG. 8 is a diagram showing a combination of pressure in a gas container in the third embodiment.

FIG. 9A is a diagram schematically showing a change in cross-sectional shape of a liquid flow path in a fourth embodiment.

FIG. 9B is a diagram schematically showing the change in cross-sectional shape of the liquid flow path in the fourth embodiment.

FIG. 10A is a diagram schematically showing a cross-sectional shape of a liquid flow path of another embodiment.

FIG. 10B is a diagram schematically showing a cross-sectional shape of a liquid flow path of another embodiment.

### DESCRIPTION OF EMBODIMENTS

### 1. First Embodiment

### 1-1. Configuration of Liquid Ejection Apparatus

A liquid ejection apparatus 1 of the present embodiment will hereinafter be described with reference to the drawings.

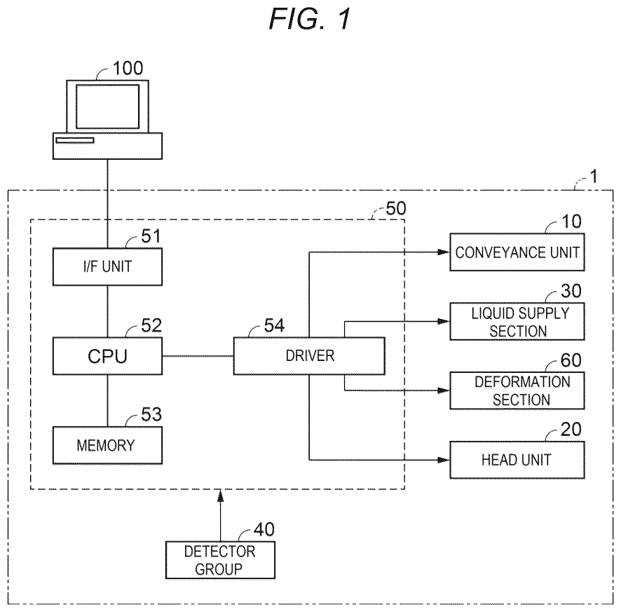

The liquid ejection apparatus 1 illustrated in FIG. 1 is an inkjet printer that prints an image such as a character or a photograph on a medium by ejecting a liquid onto a medium such as paper or cloth conveyed.

As illustrated in FIG. 1, the liquid ejection apparatus 1 includes a conveyance unit 10, a head unit 20, a liquid supply section 30, a detector group 40, a controller 50, and a deformation section 60. The liquid ejection apparatus 1 that has received print data from a computer 100 as an external apparatus controls the conveyance unit 10, the head unit 20, the liquid supply section 30, the deformation section 60, and so on with the controller 50. The controller 50 prints an image on the medium based on the print data received from the computer 100. A printing situation of the liquid ejection apparatus 1 is monitored by the detector group 40, and the detector group 40 outputs the detection result to the controller 50. The controller 50 controls the conveyance unit 10, the head unit 20, the liquid supply section 30, the deformation section 60, and so on based on the detection result output from the detector group 40.

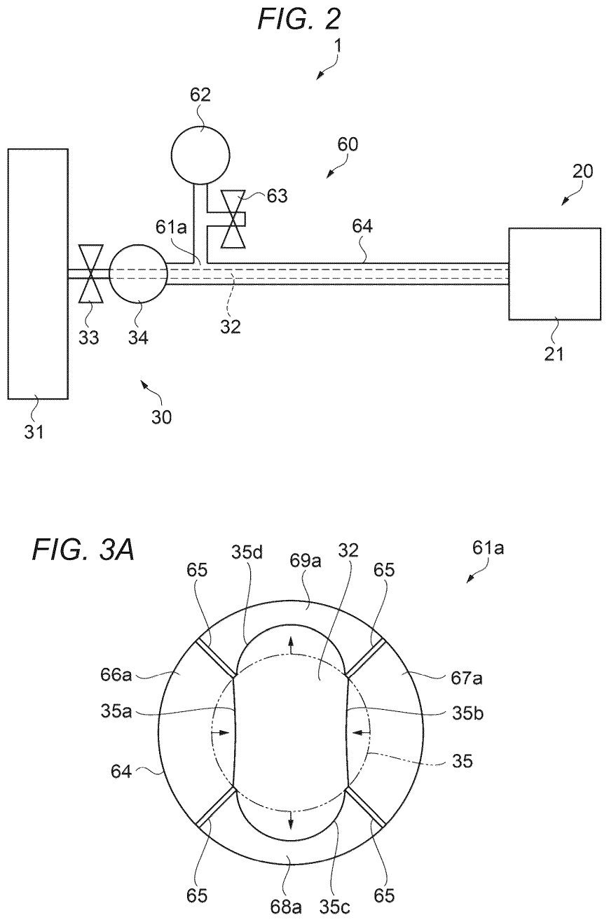

The conveyance unit 10 conveys the medium. The head unit 20 includes a carriage (not illustrated) and a liquid ejection unit 21 (see FIG. 2). The liquid ejection unit 21 is mounted on the carriage. The liquid ejection unit 21 ejects the liquid onto the medium. By the carriage moving in a scanning direction crossing a direction in which the medium is conveyed, the liquid ejection unit 21 also moves in the scanning direction. A nozzle array (not illustrated) is disposed at a lower surface of the liquid ejection unit 21. The liquid ejection unit 21 performs printing on the medium by ejecting the liquid from the nozzle array while moving in the scanning direction.

The liquid supply section 30 supplies the liquid to the liquid ejection unit 21. Detailed configurations of the liquid supply section 30 and the deformation section 60 will be described later.

The detector group 40 includes a sensor (not illustrated) that detects conveyance of the medium by the conveyance unit 10 and an encoder (not illustrated) for detecting an amount of rotation of a conveyance roller (not illustrated) that conveys the medium. Further, the detector group 40 includes a linear encoder (not illustrated) for detecting the position in the movement direction of the carriage and so on.

The controller 50 is a control unit for performing control of the liquid ejection apparatus 1. The controller 50 includes an interface (I/F) unit 51, a central processing unit (CPU) 52, a memory 53, and a driver 54.

The I/F unit 51 transmits and receives data between the computer 100 and the liquid ejection apparatus 1. The CPU 52 is an arithmetic processing device for controlling the liquid ejection apparatus 1. The memory 53 ensures an area for storing a program and a work area of the CPU 52 and so on. Further, the memory 53 stores image data to be a print target. The CPU 52 controls the conveyance unit 10, the head unit 20, the liquid supply section 30, the deformation section 60, and so on via the driver 54 in accordance with the program stored in the memory 53 to execute various types of processing.

For example, the CPU 52 causes the driver 54 to eject the liquid from the nozzle array of the liquid ejection unit 21 based on the image data stored in the memory 53 to thereby execute processing of printing the image represented as the image data on the medium.

### 1-2. Configuration of Liquid Supply Section

A configuration of the liquid supply section 30 will be described with reference to FIG. 2.

As illustrated in FIG. 2, the liquid supply section 30 includes a liquid reservoir 31, a liquid flow path 32, a liquid valve 33, and a liquid supply pump 34.

The liquid reservoir 31 is a container that stores the liquid. The liquid reservoir 31 is detachably attached to the liquid ejection apparatus 1, but this is not a limitation. The liquid reservoir 31 may be fixed to the liquid ejection apparatus 1. Note that since the liquid stored in the liquid reservoir 31 is stored in a vacuum state, deterioration of the liquid hardly occurs. In addition, the liquid in the present embodiment is sedimentary ink. Examples of the sedimentary ink include pigment ink. The ink containing a sedimentation component large in particle diameter, such as pigment ink, is likely to generate sedimentation. When using the sedimentary ink as in the present embodiment, when the apparatus is not in use, the concentration of the liquid in the liquid flow path 32 tends to be high at the lower side in a direction of gravitational force and low at the upper side in the direction of gravitational force.

The liquid flow path 32 is a hollow member through which the liquid can flow. In addition, the liquid flow path 32 is a member having flexibility. One end of the liquid flow path 32 is coupled to the liquid reservoir 31 and the other end thereof is coupled to the liquid ejection unit 21. The liquid flow path 32 supplies the liquid from the liquid reservoir 31 to the liquid ejection unit 21.

The liquid valve 33 is disposed in the middle of the liquid flow path 32. The liquid valve 33 is disposed between the liquid reservoir 31 and the liquid supply pump 34 to switch a communication state between the liquid reservoir 31 and the liquid supply pump 34. That is, when the liquid valve 33 is in an open state, the liquid supply pump 34 can deliver the liquid stored in the liquid reservoir 31 to the liquid ejection unit 21. On the other hand, when the liquid valve 33 is in a closed state, the liquid supply pump 34 cannot deliver the liquid stored in the liquid reservoir 31 to the liquid ejection unit 21.

The liquid supply pump 34 is disposed in the middle of the liquid flow path 32. The liquid supply pump 34 is disposed between the liquid valve 33 and the liquid ejection unit 21. The liquid supply pump 34 delivers the liquid stored in the liquid reservoir 31 to the liquid ejection unit 21 via the liquid flow path 32. As the liquid supply pump 34, it is possible to apply, for example, a tube pump that generates pressure by a revolving roller crushing the liquid flow path 32 that has flexibility and is arranged in an annular shape to transfer the liquid. The liquid flow path 32 is filled with the liquid pressurized by the liquid supply pump 34 to have liquid pressure P of, for example, 40 kPa to 50 kPa. Note that the liquid valve 33 and the liquid supply pump 34 are controlled by the controller 50.

### 1-3. Configuration of Deformation Section

A configuration of the deformation section 60 will be described with reference to FIG. 2.

The deformation section 60 includes a gas container 61a, a gas pump 62, a gas valve 63, and a tube 64. Note that, in FIG. 2, a single gas container 61a is illustrated, but it is sufficient that a necessary number of gas containers 61a are provided in accordance with a control pattern described later or the number of liquid flow paths 32 laid in the liquid ejection apparatus 1. The same applies to the gas pump 62, the gas valve 63, and the tube 64.

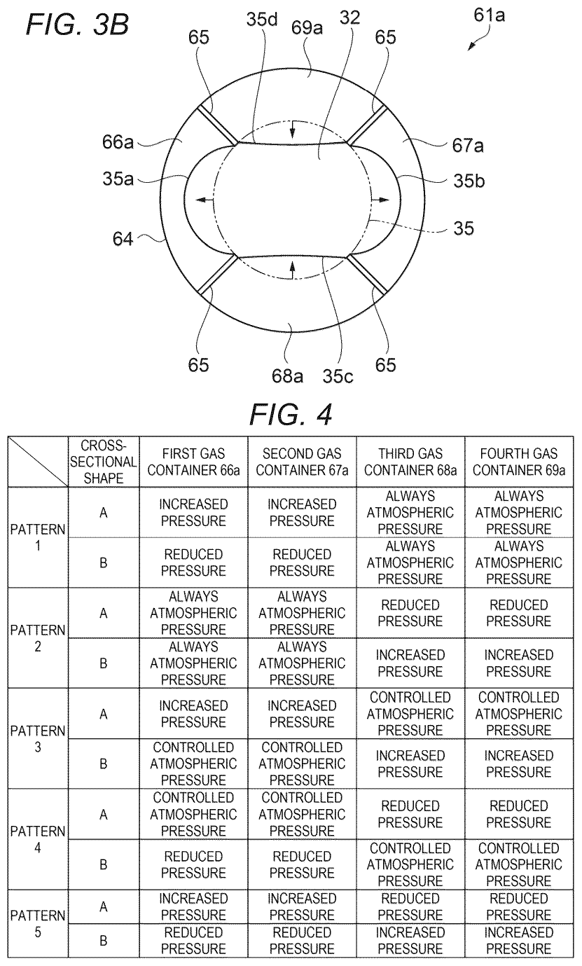

The gas container 61a changes a cross-sectional shape of the liquid flow path 32. The gas container 61a is a hollow member capable of storing gas. The gas container 61a is a flexible member. A sealed space is formed in the gas container 61a by the gas pump 62 and the gas valve 63. The gas container 61a is disposed at an outer surface 35 (see FIGS. 3A and 3B) of the liquid flow path 32. Further, the gas container 61a is disposed along an extending direction of the liquid flow path 32.

The gas pump 62 is coupled to the gas container 61a. The gas pump 62 can control the pressure in the gas container 61a. The gas pump 62 is an example of a “pressure controller”. As the gas pump 62, a pressurizing pump, a depressurizing pump, a single pump device used as both the pressurizing pump and the depressurizing pump, or the like can be applied. As a specific example of the gas pump 62, a tube pump, a diaphragm pump, a syringe pump, or the like may be applied, or the liquid supply pump 34 may also be used as the gas pump 62.

The gas valve 63 is coupled to the gas container 61a to which the gas pump 62 is coupled. The pressure in the gas container 61a is controlled to be increased pressure or reduced pressure by the gas pump 62 in a state where the gas valve 63 is closed. Further, the pressure in the gas container 61a is released to the atmosphere so as to be the atmospheric pressure by opening the gas valve 63. The gas pump 62 and the gas valve 63 are controlled by the controller 50.

In this way, the gas pump 62 can control the pressure in the gas container 61a to be increased pressure, reduced pressure, and the atmospheric pressure by being combined with the control of the gas valve 63. Note that the gas pump 62 and the gas valve 63 may be coupled to an end portion of the gas container 61a.

The tube 64 is a tubular member. The liquid flow path 32 and the gas container 61a are disposed in one tube 64. The tube 64 is preferably a member harder than the gas container 61a. Note that when the liquid ejection apparatus 1 is configured to eject a plurality of colors of pigment ink, the liquid ejection apparatus 1 may include a plurality of tubes 64 corresponding to the liquid flow paths 32 of the respective colors.

### 1-4. Configuration of Gas Container

The configuration of the gas container 61a will be described with reference to FIGS. 3A and 3B.

As illustrated in FIG. 3A, the gas container 61a includes a first gas container 66a, a second gas container 67a, a third gas container 68a, a fourth gas container 69a, and four partition walls 65 inside the tube 64. The first gas container 66a, the second gas container 67a, the third gas container 68a, and the fourth gas container 69a are disposed at respective positions different from each other. A space in the gas container 61a is partitioned into four regions of first to fourth gas containers by the four partition walls 65. The first gas container 66a, the second gas container 67a, the third gas container 68a, and the fourth gas container 69a are flexible hollow members. The partition walls 65 are preferably members harder than the first gas container 66a, the second gas container 67a, the third gas container 68a, and the fourth gas container 69a.

The first gas container 66a, the second gas container 67a, the third gas container 68a, the fourth gas container 69a, and the four partition walls 65 are disposed along the extending direction of the liquid flow path 32. The first gas container 66a, the second gas container 67a, the third gas container 68a, and the fourth gas container 69a can each individually form a sealed space. The pressure in the sealed space of each of the first gas container 66a, the second gas container 67a, the third gas container 68a, and the fourth gas container 69a is individually controlled by the gas pump 62 (see FIG. 2) and the gas valve 63 (see FIG. 2). As a result, the sealed spaces, which are an example of spaces different in internal pressure, are formed in the gas container 61a.

The liquid flow path 32 is disposed inside the tube 64. The outer surface 35 of the liquid flow path 32 is surrounded by the first gas container 66a, the second gas container 67a, the third gas container 68a, and the fourth gas container 69a. The liquid flow path 32 is sandwiched between the first gas container 66a and the second gas container 67a. In addition, the liquid flow path 32 is sandwiched between the third gas container 68a and the fourth gas container 69a. The first gas container 66a is disposed adjacent to the third gas container 68a and the fourth gas container 69a. Further, the second gas container 67a is disposed adjacent to the third gas container 68a and the fourth gas container 69a. The liquid flow path 32 is supported by the four partition walls 65 in the vicinity of the center of the gas container 61a, that is, in the vicinity of the center of the tube 64 in a cross-section crossing the extending direction of the gas container 61a. In the present embodiment, a cross-sectional shape of the liquid flow path 32 in an unloaded condition is a circular shape.

As illustrated in FIGS. 3A and 3B, when the pressure in the gas container 61a is the atmospheric pressure, the cross-sectional shape of the outer surface 35 of the liquid flow path 32 is a circular shape as indicated by a dashed-two dotted line. Further, the volume of an inside of the gas container 61a increases when the pressure in the gas container 61a is controlled to be increased pressure, and decreases when the pressure is controlled to be reduced pressure. As a result, the cross-sectional shape of the outer surface 35 of the liquid flow path 32 changes from the circular shape indicated by the dashed-two dotted line to a non-circular shape indicated by a solid line.

The gas pump 62 may be coupled one by one to each of the first gas container 66a, the second gas container 67a, the third gas container 68a, and the fourth gas container 69a. Alternatively, the gas pump 62 as a single gas pump may be coupled to two or more of the first to fourth gas containers, and the single gas pump 62 may be shared by the two or more gas containers.

Alternatively, the gas pump 62 is not required to be coupled to any of the first gas container 66a, the second gas container 67a, the third gas container 68a, and the fourth gas container 69a, or may be coupled in combination of the coupling configurations described above. That is, it is sufficient that at least one gas pump 62 is coupled to the gas container 61a in accordance with a control pattern for changing the cross-sectional shape of the liquid flow path 32.

When the pressure in the gas container 61a is always set to be the atmospheric pressure, the gas valve 63 is always set in an open state. Note that when the pressure in the gas container 61a is always set to be the atmospheric pressure, there may be adopted a configuration in which the gas valve 63 is eliminated by providing an opening communicating with the atmosphere to the gas container 61a. In addition, when the control of switching the pressure in the gas container 61a “from increased pressure to atmospheric pressure”, “from atmospheric pressure to increased pressure”, “from reduced pressure to atmospheric pressure”, or “from atmospheric pressure to reduced pressure” is not performed, the gas valve 63 is not required to be coupled to the gas container 61a.

By configuring the deformation section 60 in such a manner as described above, the cross-sectional shape of the liquid flow path 32 can be changed in various control patterns.

### 1-5. Control Patterns for Changing Cross-sectional Shape of Liquid Flow Path

The control patterns for changing the cross-sectional shape of the liquid flow path 32 will be described with reference to FIGS. 3A, 3B, and 4.

The change in the cross-sectional shape of the liquid flow path 32 illustrated in FIGS. 3A and 3B is realized by PATTERNS 1 to 5 illustrated in FIG. 4. In FIG. 4, “A” described in a field of the cross-sectional shape represents the cross-sectional shape shown in FIG. 3A, and “B” represents the cross-sectional shape shown in FIG. 3B. In FIG. 4, the pressure of each of the first to fourth gas containers when the cross-sectional shape is deformed into “A” and “B” in the five control patterns is described. The controller 50 alternately deforms the cross-sectional shape of the liquid flow path 32 into “A” and “B” by controlling the gas pump 62 and the gas valve 63 with any of the control patterns.

In addition, in FIG. 4, increased pressure means that the pressure in the gas container 61a becomes higher than the liquid pressure P of the liquid which fills the liquid flow path 32 with the gas pump 62. Further, the always atmospheric pressure means that the pressure in the gas container 61a is always opened to the atmosphere to be set to be the atmospheric pressure. Further, the controlled atmospheric pressure means that the pressure in the gas container 61a becomes the atmospheric pressure due to the control of opening the gas valve 63. Further, the reduced pressure means that the pressure in the gas container 61a becomes lower than the atmospheric pressure with the gas pump 62.

In PATTERNS 1 to 5 illustrated in FIG. 4, a magnitude relationship of the increased pressure, the always atmospheric pressure, the controlled atmospheric pressure, and the reduced pressure is as follows.
(increased pressure)>(always atmospheric pressure)=(controlled atmospheric pressure)>(reduced pressure)

Note that the pressure increased by the gas pump 62 is higher than the liquid pressure P of the liquid which fills the liquid flow path 32. That is, the magnitude relationship between the increased pressure and the liquid pressure P is as follows.
(increased pressure)>(liquid pressure P)

In addition, when the cross-sectional shape of the liquid flow path 32 is changed by reducing the pressure, it is desirable that at least a part of the gas container 61a is attached to a part of the liquid flow path 32. In the present embodiment, the term “attach” means that two things are disposed so as to be able to follow a change in each other's cross-sectional shape with bonding, welding, or the like.

The control of changing the cross-sectional shape of the liquid flow path 32 is performed by the deformation section 60 controlled by the controller 50 at a timing when no image is printed on the medium.

Hereinafter, when describing the control pattern, for example, when the cross-sectional shape is as illustrated in FIG. 3A in PATTERN 1 of FIG. 4, it is referred to as “PATTERN 1A”, and when the cross-sectional shape is as illustrated in FIG. 3B in PATTERN 1 of FIG. 4, it is referred to as a “PATTERN 1B”.

In PATTERN 1, the third gas container 68a and the fourth gas container 69a are at the always atmospheric pressure, and the pressure in the first gas container 66a and the pressure in the second gas container 67a are controlled. As shown in “PATTERN 1A”, when the first gas container 66 a and the second gas container 67a are controlled to be at the increased pressure by the gas pump 62, the cross-sectional shapes of the liquid flow path 32 and the gas container 61a change as shown in FIG. 3A. That is, as described above, since (increased pressure)>(liquid pressure P) is true, the cross-sectional shapes of the first gas container 66a and the second gas container 67a increase in a direction in which the liquid flow path 32 is sandwiched therebetween. As a result, an outer surface 35a of the liquid flow path 32 having contact with the first gas container 66a and an outer surface 35b of the liquid flow path 32 having contact with the second gas container 67a are pushed toward the inside of the liquid flow path 32.

Meanwhile, since the third gas container 68a and the fourth gas container 69a are always open to the atmosphere, an outer surface 35c having contact with the third gas container 68a and an outer surface 35d having contact with the fourth gas container 69a are pushed toward the outside of the liquid flow path 32.

Then, as shown in “PATTERN 1B”, when the first gas container 66a and the second gas container 67a are controlled to be at the reduced pressure by the gas pump 62, the cross-sectional shapes of the liquid flow path 32 and the gas container 61a change as shown in FIG. 3B. That is, as described above, since the magnitude relationship of the liquid pressure P, the atmospheric pressure, and the reduced pressure is as follows, the cross-sectional shapes of the first gas container 66a and the second gas container 67a decrease due to the reduced pressure.

(liquid pressure P)>(atmospheric pressure)>(reduced pressure) As a result, the outer surface 35a of the liquid flow path 32 having contact with the first gas container 66a and the outer surface 35b of the liquid flow path 32 having contact with the second gas container 67a are pulled toward the outside of the liquid flow path 32.

Meanwhile, since the third gas container 68a and the fourth gas container 69a are always open to the atmosphere, an outer surface 35c having contact with the third gas container 68a and an outer surface 35d having contact with the fourth gas container 69a are pulled toward the inside of the liquid flow path 32.

The controller 50 repeats “PATTERN 1A” and “PATTERN 1B” by controlling the deformation section 60. That is, PATTERN 1 is control in which the third gas container 68a and the fourth gas container 69a are fixed to the always atmospheric pressure, and the pressure of the first gas container 66a and the pressure of the second gas container 67a are repeatedly set alternately to the increased pressure and the reduced pressure. In this way, the deformation section 60 can change the cross-sectional shape of the liquid flow path 32 in accordance with a pressure difference between the pressure in the liquid flow path 32 and the pressure in the gas container 61a. Accordingly, the liquid in which sedimentation has occurred in the liquid flow path 32 is stirred. Note that it is sufficient to appropriately adjust the number of times the control pattern is repeated in accordance with the easiness of sedimentation or the like.

Then, PATTERN 2 as another control pattern different from PATTERN 1 in FIG. 4 will be described.

In PATTERN 2, the first gas container 66a and the second gas container 67a are at the always atmospheric pressure, and the pressure in the third gas container 68a and the pressure in the fourth gas container 69a are controlled. In “PATTERN 2A”, the first gas container 66 a and the second gas container 67a are always open to the atmosphere, and the third gas container 68a and the fourth gas container 69a are controlled to be at the reduced pressure with the gas pump 62. The cross-sectional shape of the liquid flow path 32 is also changed by “PATTERN 2A” as illustrated in FIG. 3A.

In “PATTERN 2B”, unlike the case of “PATTERN 2A”, the third gas container 68a and the fourth gas container 69a are controlled to be at the increased pressure by the gas pump 62. The cross-sectional shape of the liquid flow path 32 is also changed by “PATTERN 2B” as illustrated in FIG. 3B.

The controller 50 repeats “PATTERN 2A” and “PATTERN 2B” by controlling the deformation section 60. That is, PATTERN 2 is control in which the first gas container 66a and the second gas container 67a are fixed to the always atmospheric pressure, and the pressure of the third gas container 68a and the pressure of the fourth gas container 69a are repeatedly set alternately to the increased pressure and the reduced pressure. Substantially the same advantages as those of PATTERN 1 can be obtained by PATTERN 2. Note that it is sufficient to appropriately adjust the number of times the control pattern is repeated in accordance with the easiness of sedimentation or the like.

Then, PATTERN 3 as another control pattern will be described.

In PATTERN 3, each of the first to fourth gas containers is controlled. In “PATTERN 3A”, the first gas container 66a and the second gas container 67a are controlled to be at the increased pressure by the gas pump 62, and the third gas container 68a and the fourth gas container 69a are controlled to be at the controlled atmospheric pressure by opening the gas valve 63. The cross-sectional shape of the liquid flow path 32 is also changed by “PATTERN 3A” as illustrated in FIG. 3A.

In “PATTERN 3B”, the first gas container 66a and the second gas container 67a are controlled to be at the controlled atmospheric pressure by opening the gas valve 63, and the third gas container 68a and the fourth gas container 69a are controlled to be at the increased pressure pressurized by the gas pump 62. The cross-sectional shape of the liquid flow path 32 is also changed by “PATTERN 3B” as illustrated in FIG. 3B.

The controller 50 repeats “PATTERN 3A” and “PATTERN 3B” by controlling the deformation section 60. That is, PATTERN 3 is control in which switching between control of the first gas container 66a and the second gas container 67a and control of the third gas container 68a and the fourth gas container 69a is alternately repeated in order to realize the pressure difference between the increased pressure and the controlled atmospheric pressure. Substantially the same advantages as those of PATTERN 1 can be obtained by PATTERN 3. Note that it is sufficient to appropriately adjust the number of times the control pattern is repeated in accordance with the easiness of sedimentation or the like.

Then, PATTERN 4 as another control pattern will be described.

In PATTERN 4, each of the first to fourth gas containers is controlled, but unlike the case of PATTERN 3, the control is performed with the controlled atmospheric pressure and the reduced pressure combined with each other. In “PATTERN 4A”, the first gas container 66a and the second gas container 67a are controlled to be at the controlled atmospheric pressure by opening the gas valve 63, and the third gas container 68a and the fourth gas container 69a are controlled to be at the reduced pressure by the gas pump 62. The cross-sectional shape of the liquid flow path 32 is also changed by “PATTERN 4A” as illustrated in FIG. 3A.

In the “PATTERN 4B”, the first gas container 66 a and the second gas container 67a are controlled to be at the reduced pressure by the gas pump 62, and the third gas container 68a and the fourth gas container 69a are controlled to be at the controlled atmospheric pressure by opening the gas valve 63. The cross-sectional shape of the liquid flow path 32 is also changed by “PATTERN 4B” as illustrated in FIG. 3B.

The controller 50 repeats “PATTERN 4A” and “PATTERN 4B” by controlling the deformation section 60. That is, PATTERN 4 is control in which switching between control of the first gas container 66a and the second gas container 67a and control of the third gas container 68a and the fourth gas container 69a is alternately repeated in order to realize the pressure difference between the controlled atmospheric pressure and the reduced pressure. Substantially the same advantages as those of PATTERN 1 can be obtained by PATTERN 4. Note that it is sufficient to appropriately adjust the number of times the control pattern is repeated in accordance with the easiness of sedimentation or the like.

Then, PATTERN 5 as another control pattern will be described.

In PATTERN 5, four gas containers are controlled, but unlike the case of PATTERN 3, the control is performed with the increased pressure and the reduced pressure combined with each other. In “PATTERN 5A”, the first gas container 66a and the second gas container 67a are controlled to be at the increased pressure by the gas pump 62, and the third gas container 68a and the fourth gas container 69a are controlled to be at the reduced pressure by the gas pump 62. The cross-sectional shape of the liquid flow path 32 is also changed by “PATTERN 5A” as illustrated in FIG. 3A.

In “PATTERN 5B”, the first gas container 66a and the second gas container 67a are controlled to be at the reduced pressure by the gas pump 62, and the third gas container 68a and the fourth gas container 69a are controlled to be at the increased pressure by the gas pump 62. The cross-sectional shape of the liquid flow path 32 is also changed by “PATTERN 5B” as illustrated in FIG. 3B.

The controller 50 repeats “PATTERN 5A” and “PATTERN 5B” by controlling the deformation section 60. That is, PATTERN 5 is control in which switching between control of the first gas container 66a and the second gas container 67a and control of the third gas container 68a and the fourth gas container 69a is alternately repeated in order to realize the pressure difference between the increased pressure and the reduced pressure. In PATTERN 5A, the cross-sectional shape of the liquid flow path 32 can be more effectively changed than in PATTERN 1. Note that it is sufficient to appropriately adjust the number of times the control pattern is repeated in accordance with the easiness of sedimentation or the like.

Note that when the control of one gas container is switched “from the increased pressure to the reduced pressure” or “from the reduced pressure to the increased pressure”, the gas pump 62 for increasing the pressure and the gas pump 62 for reducing the pressure may separately be coupled to the one gas container, but this is not a limitation. For example, output of one end side of one tube pump may be coupled to be used for increasing the pressure, or the other end side of the one tube pump may be coupled to be used for reducing the pressure. When one tube pump is used, since the pressure at one end side and the pressure at the other end side of the one tube pump have an inversely proportional relationship, it is possible to suppress a fluctuation of the liquid pressure P of the liquid that fills the liquid flow path 32.

In addition, since the liquid flow path 32 is a member having flexibility, for example, it is possible to change the cross-sectional shape of the liquid flow path 32 so as to switch between a long axis of the cross-sectional shape of the liquid flow path 32 illustrated in FIG. 3A and a short axis of the cross-sectional shape of the liquid flow path 32 illustrated in FIG. 3B. Accordingly, even when the cross-sectional shape of the liquid flow path 32 is changed, it is possible to suppress a change in the cross-sectional area of the liquid flow path 32. In this way, since it is possible to suppress the change in the cross-sectional area of the liquid flow path 32, it is possible to suppress the change in volume in the liquid flow path 32. That is, it is possible to suppress a change in pressure in the liquid flow path 32. Note that when the change in the pressure in the liquid flow path 32 is not sufficiently suppressed, the liquid ejection apparatus 1 may have a configuration of adjusting the change in the pressure in the liquid flow path 32.

Further, in the present embodiment, it is desirable that both the tube 64 and the partition walls 65 are members harder than the gas container 61a. Accordingly, when the pressure in the gas container 61a is changed, the direction in which the cross-sectional shape of the gas container 61a changes can be regulated to the direction toward the liquid flow path 32. Accordingly, the cross-sectional shape of the liquid flow path 32 can be efficiently changed.

Note that in PATTERN 1, the first gas container 66a and the second gas container 67a, which are controlled to be at the increased pressure or the reduced pressure by the gas pump 62, are examples of a “controlled container”, the pressure of which is controlled by the gas pump 62. Further, the third gas container 68a and the fourth gas container 69a, which are at the always atmospheric pressure, are examples of an “uncontrolled container”, the pressure of which is not controlled by the gas pump 62. In addition, in PATTERN 2, the first gas container 66a and the second gas container 67a are examples of the “uncontrolled container”, and the third gas container 68a and the fourth gas container 69a are examples of the “controlled container”. In PATTERNS 3 to 5, the first to fourth gas containers are all examples of the “controlled container”.

As described above, as shown in FIGS. 3A and 3B, the liquid flow path 32 is sandwiched between the first gas container 66a and the second gas container 67a. Further, as illustrated in PATTERNS 1, 3 to 5 in FIG. 4, the gas pump 62 can control the pressure in the first gas container 66a and the pressure in the second gas container 67a wherein the liquid flow path 32 is sandwiched between the first gas container 66a and the second gas container 67a. Further, when the gas pump 62 controls the pressure in the first gas container 66a to a first pressure P1, the gas pump 62 controls the pressure in the second gas container 67a to the first pressure P1. Note that as the first pressure P1 in PATTERNS 1, 3 to 5 in FIG. 4, any one of the increased pressure, the reduced pressure, and the controlled atmospheric pressure is selected.

Further, as shown in PATTERNS 3 to 5 in FIG. 4, the gas pump 62 can control the pressure in the third gas container 68a and the pressure in the fourth gas container 69a. Further, when controlling the pressure in the first gas container 66a and the pressure in the second gas container 67a to the first pressure P1, the gas pump 62 controls the pressure in the third gas container 68a and the pressure in the fourth gas container 69a to a second pressure P2 different from the first pressure P1. Further, when the gas pump 62 controls the pressure in the third gas container 68a and the pressure in the fourth gas container 69a to the first pressure P1, the gas pump 62 controls the pressure in the first gas container 66a and the pressure in the second gas container 67a to the second pressure P2.

Note that hereinafter, the second pressure P2 in PATTERNS 3 to 5 in FIG. 4 represents the controlled atmospheric pressure or the reduced pressure when the first pressure P1 is the increased pressure, represents the controlled atmospheric pressure or the increased pressure when the first pressure P1 is the reduced pressure, and represents the reduced pressure or the increased pressure when the first pressure P1 is the controlled atmospheric pressure. For example, in the case of PATTERN 3 and PATTERN 4 in FIG. 4, the second pressure P2 is the atmospheric pressure.

As described hereinabove, according to the liquid ejection apparatus 1 of the first embodiment, the following advantages can be obtained.

According to the liquid ejection apparatus 1, the liquid ejection apparatus 1 includes the liquid reservoir 31 capable of storing the liquid, the liquid ejection unit 21 capable of ejecting the liquid, the liquid flow path 32 that supplies the liquid from the liquid reservoir 31 to the liquid ejection unit 21, and the deformation section 60 having the gas container 61a that changes the cross-sectional shape of the liquid flow path 32. As a result, the liquid that has caused the sediment in the liquid flow path 32 can be stirred by changing the cross-sectional shape of the liquid flow path 32, and therefore, the sedimentation of the liquid can effectively be prevented.

According to the liquid ejection apparatus 1, the deformation section 60 includes the gas container 61a disposed at the outer surface 35 of the liquid flow path 32 and the gas pump 62 capable of controlling the pressure of the gas container 61a. In addition, the deformation section 60 changes the cross-sectional shape of the liquid flow path 32 in accordance with the pressure difference between the pressure in the liquid flow path 32 and the pressure in the gas container 61a. By the deformation section 60 controlling the pressure applied to the gas container 61a, spaces different in internal pressure from each other are formed in the gas container 61a. Accordingly, it is possible to stir the liquid that has caused the sediment in the liquid flow path 32 by changing the cross-sectional shape of the liquid flow path 32. In addition, since it is only required to control the pressure applied to the gas container 61a, it is possible to simplify the configuration of the liquid ejection apparatus 1. For example, a configuration in which a stirring unit that stirs the liquid is not disposed in the liquid reservoir 31 capable of storing the liquid may be adopted, or a configuration not provided with a configuration of a flow path for returning the liquid located in the liquid ejection unit 21 to the liquid reservoir 31 may be adopted.

According to the liquid ejection apparatus 1, for example, in PATTERN 1 in FIG. 4, the gas container 61a includes the first gas container 66a, the pressure of which is controlled by the gas pump 62, and the second gas container 67a, the pressure of which is controlled by the gas pump 62. Further, the gas container 61a includes the third gas container 68a, the pressure of which is not controlled by the gas pump 62, and the fourth gas container 69a, the pressure of which is not controlled by the gas pump 62. Accordingly, the cross-sectional area of each of the third gas container 68a and the fourth gas container 69a follows the change in the cross-sectional area of each of the first gas container 66a and the second gas container 67a caused by the gas pump 62 so as to cancel the change. That is, it is possible to change the cross-sectional shape of the liquid flow path 32 without significantly changing the cross-sectional area of the liquid flow path 32. Further, accordingly, it is possible to stir the liquid in the liquid flow path 32 without separately providing a configuration for adjusting the change in pressure in the liquid flow path 32.

According to the liquid ejection apparatus 1, the liquid flow path 32 is sandwiched between the first gas container 66a and the second gas container 67a, and the gas pump 62 can control the pressure in the first gas container 66a and the pressure in the second gas container 67a. As described above, by controlling the pressure in the first gas container 66a and the pressure in the second gas container 67a, the cross-sectional shape of the liquid flow path 32 sandwiched between the first gas container 66a and the second gas container 67a can be changed to various shapes. Therefore, the liquid in the liquid flow path 32 can be effectively stirred.

According to the liquid ejection apparatus 1, when the gas pump 62 controls the pressure in the first gas container 66a to the first pressure P1, the gas pump 62 can make it easy to change the cross-sectional shape of the liquid flow path 32 by controlling the pressure in the second gas container 67a to the first pressure P1.

According to the liquid ejection apparatus 1, the gas pump 62 can control the third gas container 68a and the fourth gas container 69a disposed at the positions different from the positions of the first gas container 66a and the second gas container 67a. Further, when controlling the pressure in the first gas container 66a and the pressure in the second gas container 67a to the first pressure P1, the gas pump 62 controls the pressure in the third gas container 68a and the pressure in the fourth gas container 69a to the second pressure P2 different from the first pressure P1. Further, when the gas pump 62 controls the pressure in the third gas container 68a and the pressure in the fourth gas container 69a to the first pressure P1, the gas pump 62 controls the pressure in the first gas container 66a and the pressure in the second gas container 67a to the second pressure P2. Accordingly, it is possible to make it easy to effectively change the cross-sectional shape of the liquid flow path 32.

According to the liquid ejection apparatus 1, in PATTERNS 3, 4, the second pressure P2 is the atmospheric pressure. Accordingly, since it is sufficient to perform only the control of opening the gas valve 63 to the atmosphere, the configuration of the liquid ejection apparatus 1 can be simplified.

According to the liquid ejection apparatus 1, the cross-sectional shape of the liquid flow path 32 is a circular shape, the gas container 61a has the partition walls 65 that partition the space in the gas container 61a into a plurality of regions, and the partition walls 65 support the liquid flow path 32. Accordingly, compared to when the cross-sectional shape of the liquid flow path 32 is a non-circular shape, it is possible to reduce the change in the cross-sectional shape of the lower portion in the direction of gravitational force, which particularly affects the sedimentation of the liquid, even when the posture of the liquid flow path 32 changes due to the cross-sectional shape of the liquid flow path 32 rotating around an axis along the extending direction of the liquid flow path 32. Accordingly, since it is possible to make it difficult to be affected by the sedimentation of the liquid even when the posture of the liquid flow path 32 changes, it is possible to efficiently stir the liquid in the liquid flow path 32.

According to the liquid ejection apparatus 1, since the liquid flow path 32 and the gas container 61a are disposed in the single tube 64, the configuration of the liquid ejection apparatus 1 can be simplified.

According to the liquid ejection apparatus 1, since the plurality of tubes 64 each having the liquid flow path 32 and the gas container 61a formed inside is provided, it is possible to stir the liquid in the plurality of liquid flow paths 32.

### 2. Second Embodiment

### 2-1. Configuration of Gas Container

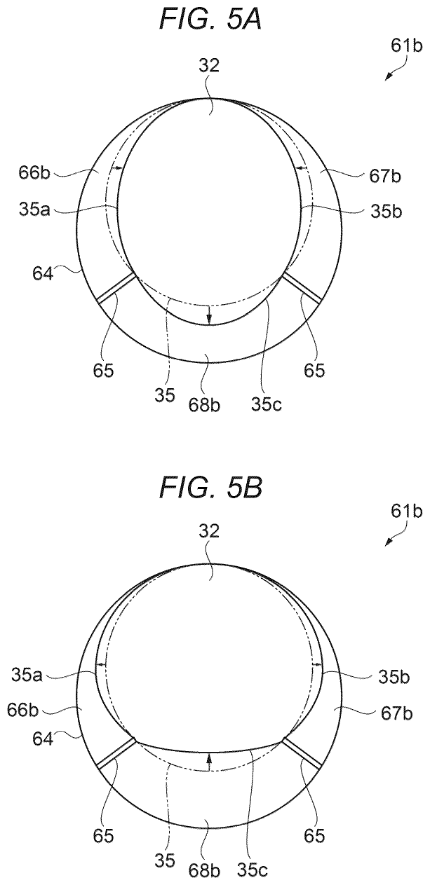

A configuration of a gas container 61b will be described with reference to FIGS. 5A and 5B.

In a second embodiment, the deformation section 60 includes the gas container 61b illustrated in FIGS. 5A and 5B, unlike the gas container 61a described in the first embodiment. Further, also in the second embodiment, the configurations related to the gas pump 62, the gas valve 63, and the liquid pressure P are substantially the same as those in the first embodiment. In FIGS. 5A and 5B, the same components as those in the drawings having already been described are denoted by the same reference numerals to omit the detailed description thereof.

As illustrated in FIG. 5A, the gas container 61b includes, inside the tube 64, a first gas container 66b, a second gas container 67b, a third gas container 68b, and two partition walls 65. The first gas container 66b, the second gas container 67b, and the third gas container 68b are disposed at respective positions different from each other. The space in the gas container 61b is partitioned into three regions of the first to third gas containers by the two partition walls 65 and a part of the liquid flow path 32 being in contact with a part of the tube 64.

The first gas container 66b, the second gas container 67b, and the third gas container 68b are flexible hollow members. The partition walls 65 are preferably members harder than the first gas container 66b, the second gas container 67b, and the third gas container 68b. Further, the first gas container 66b, the second gas container 67b, the third gas container 68b, and the two partition walls 65 are each disposed along the extending direction of the liquid flow path 32. The first gas container 66b, the second gas container 67b, and the third gas container 68b can each individually form a sealed space. The pressure in the sealed space of each of the first gas container 66b, the second gas container 67b, and the third gas container 68b is individually controlled by the gas pump 62 (see FIG. 2) and the gas valve 63 (see FIG. 2).

The liquid flow path 32 is disposed inside the tube 64. The outer surface 35 of the liquid flow path 32 is surrounded by the first gas container 66b, the second gas container 67b, and the third gas container 68b. A part of the outer surface 35 of the liquid flow path 32 is in contact with a part of the tube 64, and the liquid flow path 32 is supported by the two partition walls 65. Also in the second embodiment, the cross-sectional shape of the outer surface 35 of the liquid flow path 32 in an unloaded condition is a circular shape as indicated by the dashed-two dotted line. Note that the liquid flow path 32 and the gas container 61b are flexible members.

As described above, the deformation section 60 in the second embodiment does not include the fourth gas container 69a in the first embodiment. As described above, even when the deformation section 60 is configured in a simplified manner, the deformation section 60 can change the cross-sectional shape of the liquid flow path 32 in various control patterns.

### 2-2. Control Patterns for Changing Cross-sectional Shape of Liquid Flow Path

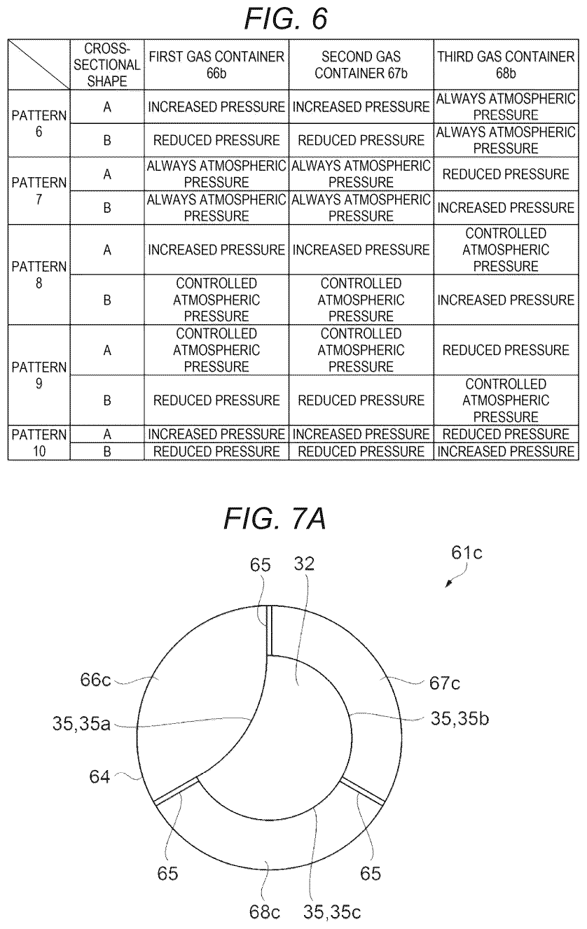

The control patterns for changing the cross-sectional shape of the liquid flow path 32 will be described with reference to FIGS. 5A, 5B, and 6.

The change in the cross-sectional shape of the liquid flow path 32 illustrated in FIG. 5A is realized by PATTERNS 6A, 7A, 8A, 9A, and 10A illustrated in FIG. 6. In addition, the change in the cross-sectional shape of the liquid flow path 32 illustrated in FIG. 5B is realized by PATTERNS 6B, 7B, 8B, 9B, and 10B illustrated in FIG. 6. In addition, in PATTERNS 6 to 10 illustrated in FIG. 6, the magnitude relationship of the increased pressure, the always atmospheric pressure, the controlled atmospheric pressure, and the reduced pressure shows the following relationship similarly to the first embodiment.
(increased Pressure)>(always Atmospheric pressure)=(controlled atmospheric pressure)>(reduced pressure)

Further, the magnitude relationship between the increased pressure and the liquid pressure P is as follows.
(increased pressure)>(liquid pressure P)

PATTERNS 6 to 10 illustrated in FIG. 6 are substantially the same as PATTERNS 1 to 5 illustrated in FIG. 4 in the first embodiment except that PATTERNS 6 to 10 do not include the control related to the fourth gas container 69a in PATTERNS 1 to 5 illustrated in FIG. 4 in the first embodiment.

As described above, substantially the same advantages as those of the first embodiment can also be obtained by the second embodiment.

### 3. Third Embodiment

### 3-1. Configuration of Gas Container

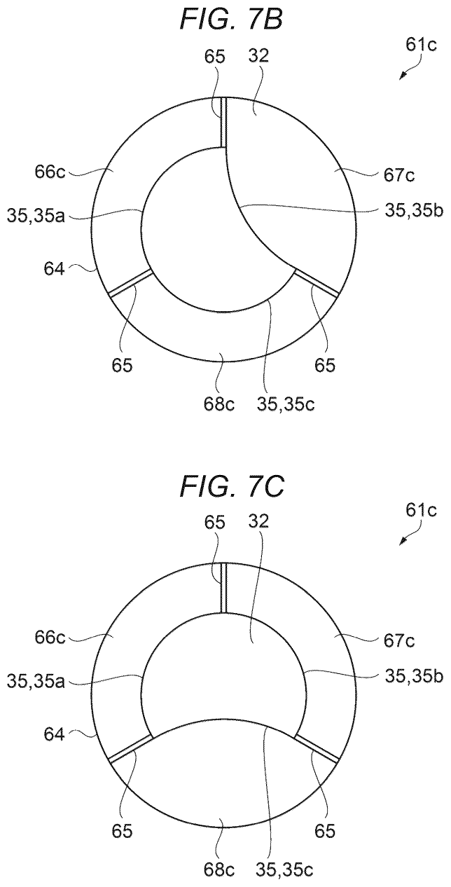

In a third embodiment, the deformation section 60 includes a gas container 61c illustrated in FIGS. 7A to 7C, unlike the gas container 61b described in the second embodiment. Further, also in the third embodiment, the configurations related to the gas pump 62, the gas valve 63, and the liquid pressure P are substantially the same as those in the second embodiment. In FIGS. 7A to 7C, the same components as those in the drawings having already been described are denoted by the same reference numerals to omit the detailed description thereof.

A configuration of the gas container 61c will be described with reference to FIGS. 7A to 7C.

As illustrated in FIG. 7A, the gas container 61c includes a first gas container 66c, a second gas container 67c, a third gas container 68c, and three partition walls 65 inside the tube 64. The first gas container 66c, the second gas container 67c, and the third gas container 68c are disposed at respective positions different from each other. A space in the gas container 61c is partitioned into three regions of the first to third gas containers by the three partition walls 65.

The first gas container 66c, the second gas container 67c, and the third gas container 68c are flexible hollow members. The partition walls 65 are preferably members harder than the first gas container 66c, the second gas container 67c, and the third gas container 68c. The first gas container 66c, the second gas container 67c, the third gas container 68c, and the three partition walls 65 are disposed along the extending direction of the liquid flow path 32. The first gas container 66c, the second gas container 67c, and the third gas container 68c can each individually form a sealed space. The pressure in the sealed space of each of the first gas container 66c, the second gas container 67c, and the third gas container 68c is individually controlled by the gas pump 62 (see FIG. 2) and the gas valve 63 (see FIG. 2).

The liquid flow path 32 is disposed inside the tube 64. The outer surface 35 of the liquid flow path 32 is sandwiched by the first gas container 66c, the second gas container 67c, and the third gas container 68c. The liquid flow path 32 is supported by the three partition walls 65 in the vicinity of the center of the gas container 61c, that is, in the vicinity of the center of the tube 64 in a cross-section crossing the extending direction of the gas container 61c. A cross-sectional shape of the liquid flow path 32 in an unloaded condition is a circular shape. In the third embodiment, in a state where the first gas container 66c is controlled to be at the first pressure P1 and the second gas container 67c and the third gas container 68c are controlled to be at a pressure equal to or lower than the atmospheric pressure, the liquid flow path 32 is filled with the liquid at the liquid pressure P lower than the first pressure P1. The cross-sectional shape of the liquid flow path 32 filled with the liquid is, for example, the shape shown in FIG. 7A.

The cross-sectional shape of the liquid flow path 32 can also be changed in various control patterns by configuring the deformation section 60 as described above.

### 3-2. Control Patterns for Changing Cross-Sectional Shape of Liquid Flow Path

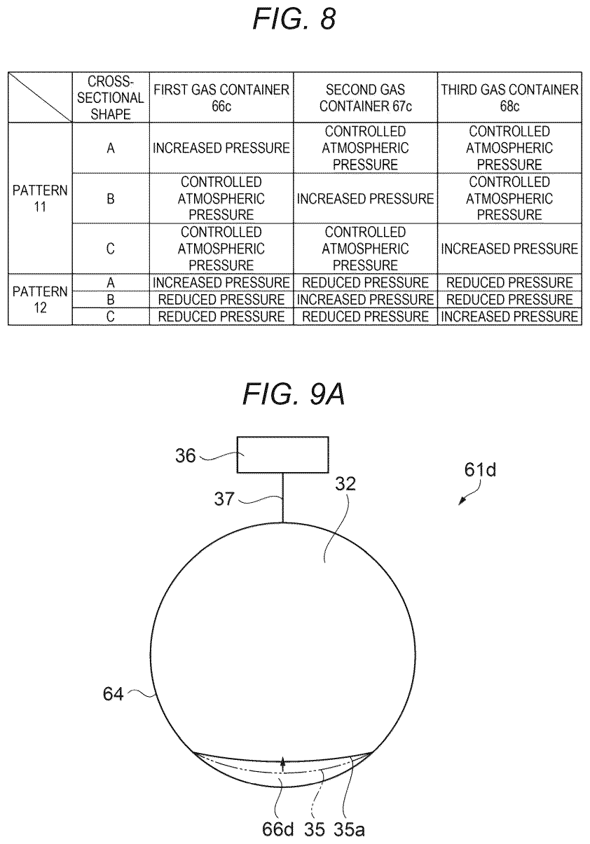

The control patterns for changing the cross-sectional shape of the liquid flow path 32 will be described with reference to FIGS. 7A to 7C, and 8.

The change in the cross-sectional shape of the liquid flow path 32 illustrated in FIG. 7A is realized by PATTERNS 11A, 12A illustrated in FIG. 8. In addition, the change in the cross-sectional shape of the liquid flow path 32 illustrated in FIG. 7B is realized by PATTERNS 11B, 12B illustrated in FIG. 8. In addition, the change in the cross-sectional shape of the liquid flow path 32 illustrated in FIG. 7C is realized by PATTERNS 11C, 12C illustrated in FIG. 8. In addition, in PATTERNS 11 and 12 illustrated in FIG. 8, the magnitude relationship of the increased pressure, the controlled atmospheric pressure, and the reduced pressure shows the following relationship.
(increased pressure)>(controlled atmospheric pressure)>(reduced pressure)

Further, the magnitude relationship between the increased pressure and the liquid pressure P is as follows.
(increased pressure)>(liquid pressure P)

In PATTERN 11, one gas container is controlled to be at the increased pressure, and the other two gas containers are controlled to be at the controlled atmospheric pressure. In PATTERN 11A in FIG. 8, the first gas container 66c is controlled to be at the increased pressure by the gas pump 62, and the second gas container 67c and the third gas container 68c are controlled to be at the controlled atmospheric pressure opened to the atmosphere by opening the gas valve 63. In the state of PATTERN 11A in FIG. 8, since the cross-sectional shape of the first gas container 66c increases in a direction of pushing the liquid flow path 32, the outer surface 35a of the liquid flow path 32 having contact with the first gas container 66c is pushed toward the inside of the liquid flow path 32.

Meanwhile, since the second gas container 67c and the third gas container 68c are open to the atmosphere in the state where the gas valve 63 is opened, the outer surface 35b of the liquid flow path 32 having contact with the second gas container 67c and the outer surface 35c of the liquid flow path 32 having contact with the third gas container 68c are pushed toward the outside of the liquid flow path 32.

Then, the controller 50 switches the control pattern illustrated in FIG. 8 from PATTERN 11A to PATTERN 11B by controlling the deformation section 60. In PATTERN 11B in FIG. 8, unlike the case of PATTERN 11A, the first gas container 66c is controlled to be at the controlled atmospheric pressure opened to the atmosphere in the state where the gas valve 63 is opened, and the second gas container 67c is controlled to be at the increased pressure by the gas pump 62. Accordingly, since the cross-sectional shape of the liquid flow path 32 in PATTERN 11B can be made the same as the cross-sectional shape of the liquid flow path 32 in PATTERN 11A, it is possible to suppress the fluctuation of the liquid pressure P of the liquid that fills the liquid flow path 32. In addition, since the portion that pushes the liquid flow path 32 inward is changed from the outer surface 35a to the outer surface 35b, the liquid located in the liquid flow path 32 can be stirred.

Then, the controller 50 switches the control pattern illustrated in FIG. 8 from PATTERN 11B to PATTERN 11C by controlling the deformation section 60. In PATTERN 11C in FIG. 8, unlike the case of PATTERN 11B, the second gas container 67c is controlled to be at the controlled atmospheric pressure opened to the atmosphere in the state where the gas valve 63 is opened, and the third gas container 68c is controlled to be at the increased pressure by the gas pump 62. Accordingly, since the cross-sectional shape of the liquid flow path 32 in PATTERN 11C can be made the same as the cross-sectional shape of the liquid flow path 32 in PATTERN 11B, it is possible to suppress the fluctuation of the liquid pressure P of the liquid that fills the liquid flow path 32. In addition, since the portion that pushes the liquid flow path 32 inward is changed from the outer surface 35b to the outer surface 35c, the liquid located in the liquid flow path 32 can be stirred.

Further, the controller 50 switches the control pattern illustrated in FIG. 8 from PATTERN 11C to PATTERN 11A by controlling the deformation section 60. Then, the controller 50 can repeat the switching of the control pattern illustrated in FIG. 8 in the order of PATTERNS 11A, 11B, and 11C by controlling the deformation section 60. Note that it is sufficient to appropriately adjust the number of times the control pattern is repeated in accordance with the easiness of sedimentation or the like.

Then, PATTERN 12 as another control pattern will be described.

In PATTERN 12, one gas container is controlled to be at the increased pressure, and the other two gas containers are controlled to be at the reduced pressure. In PATTERN 12A in FIG. 8, unlike the case of PATTERN 11A, since the second gas container 67c and the third gas container 68c are controlled to be at the reduced pressure by the gas pump 62, the cross-sectional shape of the liquid flow path 32 becomes the shape illustrated in FIG. 7A.

Then, the controller 50 switches the control pattern illustrated in FIG. 8 from PATTERN 12A to PATTERN 12B by controlling the deformation section 60. In PATTERN 12B of FIG. 8, unlike the case of PATTERN 12A, since the first gas container 66c is controlled to be at the reduced pressure by the gas pump 62 and the second gas container 67c is controlled to be at the increased pressure by the gas pump 62, the cross-sectional shape of the liquid flow path 32 becomes the shape shown in FIG. 7B.

Then, the controller 50 switches the control pattern illustrated in FIG. 8 from PATTERN 12B to PATTERN 12C by controlling the deformation section 60. In PATTERN 12C in FIG. 8, unlike the case of PATTERN 12B, since the second gas container 67c is controlled to be at the reduced pressure by the gas pump 62, and the third gas container 68c is controlled to be at the increased pressure by the gas pump 62, the cross-sectional shape of the liquid flow path 32 becomes the shape illustrated in FIG. 7C.

The controller 50 switches the control pattern illustrated in FIG. 8 from PATTERN 12C to PATTERN 12A by controlling the deformation section 60. Then, the controller 50 can repeat the switching of the control pattern illustrated in FIG. 8 in the order of PATTERNS 12A, 12B, and 12C by controlling the deformation section 60. Note that it is sufficient to appropriately adjust the number of times the control pattern is repeated in accordance with the easiness of sedimentation or the like.

In this way, the deformation section 60 can change the cross-sectional shape of the liquid flow path 32 in accordance with a pressure difference between the pressure in the liquid flow path 32 and the pressure in the gas container 61c. Accordingly, the liquid in which sedimentation has occurred in the liquid flow path 32 is stirred.

In other words, in the third embodiment, the controller 50 switches the cross-sectional shape in the order of FIG. 7A, FIG. 7B, and FIG. 7C by controlling the deformation section 60. That is, for example, as shown in PATTERN 11A in FIG. 8, when the gas pump 62 controls the pressure in the first gas container 66c to the first pressure P1, the gas pump 62 controls the pressure in the second gas container 67c and the pressure in the third gas container 68c to the second pressure P2 lower than the first pressure P1. Then, as shown in PATTERN 11B in FIG. 8, when the gas pump 62 controls the pressure in the second gas container 67c to the first pressure P1, the gas pump 62 controls the pressure in the first gas container 66c and the pressure in the third gas container 68c to the second pressure P2. Then, as shown in PATTERN 11C in FIG. 8, when the gas pump 62 controls the pressure in the third gas container 68c to the first pressure P1, the gas pump 62 controls the pressure in the first gas container 66c and the pressure in the second gas container 67c to the second pressure P2.

Further, in PATTERN 11, the first pressure P1 is the increased pressure, and the second pressure P2 is the atmospheric pressure. Further, in PATTERN 12, the first pressure P1 is the increased pressure, and the second pressure P2 is the reduced pressure.

As described above, according to the liquid ejection apparatus 1 of the third embodiment, it is possible to further obtain the following advantages in addition to substantially the same advantages as those of the first embodiment.

According to the liquid ejection apparatus 1, when one region out of the first gas container 66c, the second gas container 67c, and the third gas container 68c partitioned by the partition walls 65 is controlled to be at the first pressure P1, the gas pump 62 controls the pressure in other regions to the second pressure P2 lower than the first pressure P1. Further, in other words, the driver 54 switches the one region controlled to be at the first pressure P1 by the gas pump 62 to any of the first gas container 66c, the second gas container 67c, and the third gas container 68c. Accordingly, since it is possible to exhaustively pressurize the outer circumference of the liquid flow path 32, it is possible to efficiently stir the liquid in the liquid flow path 32 even when there is a change in posture such as an inclination of the cross-sectional shape of the liquid flow path 32 in the rotation direction centered on the axis along the extending direction of the liquid flow path 32.

According to the liquid ejection apparatus 1, in PATTERN 11, the second pressure P2 is the atmospheric pressure. Accordingly, since it is sufficient to perform only the control of opening the gas valve 63 to the atmosphere, the configuration of the liquid ejection apparatus 1 can be simplified.

### 4. Fourth Embodiment

### 4-1. Configuration of Gas Container

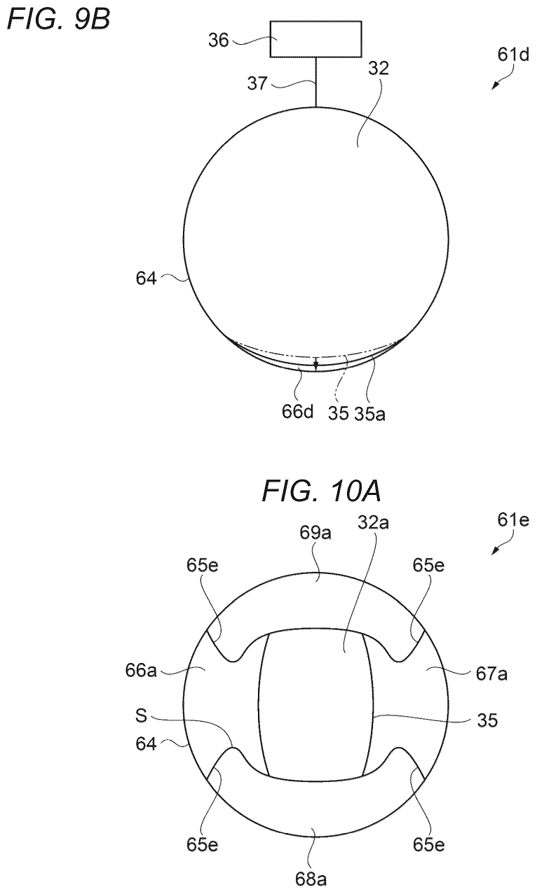

A configuration of a gas container 61d will be described with reference to FIGS. 9A and 9B.

In the fourth embodiment, the deformation section 60 includes a gas container 61d illustrated in FIGS. 9A and 9B, unlike the gas container 61b described in the second embodiment. Further, also in the fourth embodiment, the configurations related to the gas pump 62, the gas valve 63, and the liquid pressure P are substantially the same as those in the second embodiment. In the present embodiment, a liquid pressure adjustment unit 36 for adjusting the fluctuation of the liquid pressure P of the liquid that fills the liquid flow path 32 is coupled to the liquid flow path 32 via a liquid pressure adjustment flow path 37. In FIGS. 9A and 9B, the same components as those in the drawings having already been described are denoted by the same reference numerals to omit the detailed description thereof.

As illustrated in FIG. 9A, the gas container 61d includes a first gas container 66d inside the tube 64. The first gas container 66d is a flexible hollow member. Further, the first gas container 66d is disposed along the extending direction of the liquid flow path 32. The first gas container 66d can form a sealed space. The pressure in the sealed space of the first gas container 66d is controlled by the gas pump 62 (see FIG. 2).

The liquid flow path 32 is disposed inside the tube 64. The liquid flow path 32 and the first gas container 66d are housed in one tube 64 without a gap. The outer surface 35 of the liquid flow path 32 is surrounded by the tube 64 and the first gas container 66d. In the liquid flow path 32, a part of the outer surface 35 of the liquid flow path 32 is in contact with a part of the tube 64, and the outer surface 35a of the liquid flow path 32 is supported by the first gas container 66d. Also in the fourth embodiment, the cross-sectional shape of the outer surface 35 of the liquid flow path 32 in an unloaded condition is a circular shape as indicated by the dashed-two dotted line. Note that the liquid flow path 32 and the gas container 61d are flexible members.

As described above, the gas container 61d of the deformation section 60 in the fourth embodiment is not partitioned into a plurality of regions like in the second embodiment. As described above, even when the deformation section 60 is configured in a simplified manner, the deformation section 60 can change the cross-sectional shape of the liquid flow path 32 in various control patterns.

### 4-2. Control Patterns for Changing Cross-sectional Shape of Liquid Flow Path

The control patterns for changing the cross-sectional shape of the liquid flow path 32 will be described with reference to FIGS. 9A and 9B.

In PATTERN 13A (not illustrated), the first gas container 66d is controlled to be at the increased pressure by the gas pump 62. As a result, as shown in FIG. 9A, the cross-sectional shape changes. That is, since the cross-sectional shape of the first gas container 66d increases in a direction of pushing inward the outer surface 35a of the liquid flow path 32, the cross-sectional shape of the liquid flow path 32 is reduced toward the inside of the liquid flow path 32. Note that when the cross-sectional shape of the liquid flow path 32 is reduced toward the inside of the liquid flow path 32, the liquid pressure P, which is the pressure of the liquid that fills the liquid flow path 32, tends to increase, but the liquid pressure P is adjusted by the liquid pressure adjustment unit 36 so that the fluctuation of the pressure is suppressed. The liquid pressure adjustment unit 36 is, for example, a diaphragm pump.

Note that in PATTERN 13B (not illustrated), the first gas container 66d is controlled to be at the reduced pressure by the gas pump 62. As a result, as shown in FIG. 9B, the cross-sectional shape changes. That is, since the cross-sectional shape of the first gas container 66d is reduced in a direction of enlarging the liquid flow path 32, the cross-sectional shape of the liquid flow path 32 is enlarged toward the outside of the liquid flow path 32. Note that when the cross-sectional shape of the liquid flow path 32 is enlarged toward the outside of the liquid flow path 32, the liquid pressure P, which is the pressure of the liquid that fills the liquid flow path 32, tends to decrease, but the liquid pressure P is adjusted by the liquid pressure adjustment unit 36 so that the fluctuation of the pressure is suppressed.

In PATTERNS 13A and 13B described above, a magnitude relationship of the increased pressure and the reduced pressure shows the following relationship.
(increased pressure)>(reduced pressure)

Further, the magnitude relationship between the increased pressure and the liquid pressure P is as follows.
(increased pressure)>(liquid pressure P)

The controller 50 repeats PATTERN 13A and PATTERN 13B by controlling the deformation section 60. That is, PATTERN 13A and PATTERN 13B are control of repeating alternately setting the pressure of the first gas container 66d to the increased pressure and the reduced pressure. In this way, the deformation section 60 can change the cross-sectional shape of the liquid flow path 32 in accordance with a pressure difference between the pressure in the liquid flow path 32 and the pressure in the gas container 61d. Accordingly, the liquid in which sedimentation has occurred in the liquid flow path 32 is stirred. Note that it is sufficient to appropriately adjust the number of times the control pattern is repeated in accordance with the easiness of sedimentation or the like.

As described above, substantially the same advantages as those of the first embodiment can also be obtained by the fourth embodiment.

Although the embodiments are hereinabove described in detail with reference to the drawings, the specific configuration is not limited to the embodiments and may be modified, replaced, deleted, or the like without departing from the gist of the present disclosure. Further, other embodiments given below may be adopted.

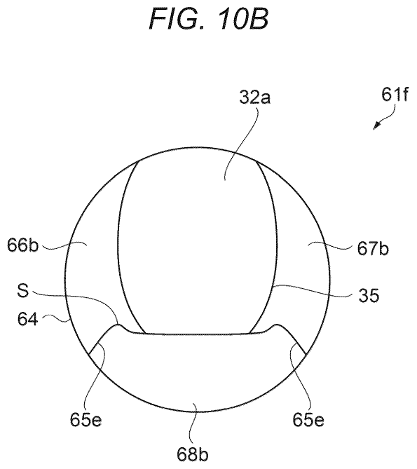

In each of the embodiments described above, a circular shape is exemplified as the cross-sectional shape of the liquid flow path 32 in an unloaded condition, but this is not a limitation. As shown in the gas container 61e in FIG. 10A and the gas container 61f in FIG. 10B, the cross-sectional shape of the liquid flow path 32a may be a non-circular shape. This also stirs the liquid in which sedimentation has occurred in the liquid flow path 32a.

In each of the embodiments described above, it is assumed that the partition walls 65 are preferably members harder than the gas container 61a, but this is not a limitation. As illustrated in FIGS. 10A and 10B, a partition wall 65e is not required to be a member harder than the gas container 61a, and the partition wall 65e may be formed by providing a slack S to a flexible member. This also stirs the liquid in which sedimentation has occurred in the liquid flow path 32.

The gas containers 61a to 61f described in the embodiments described above may be formed by extrusion molding, or may be formed by bonding the members constituting the gas containers 61a to 61f. Further, the flexibility, elasticity, hardness, and so on of each of the members constituting the gas containers 61a to 61f can be appropriately set according to the material, thickness, and so on of that member.

In the embodiments described above, it is assumed that the liquid flow path 32 and the gas containers 61a to 61f are disposed in the tube 64, but the tube 64 may be eliminated. For example, as long as the cross-sectional shape of the liquid flow path 32 can be changed while regulating the direction in which the gas containers 61a to 61f are deformed with another member or the like, the liquid flow path 32 and the gas containers 61a to 61f are not required to be disposed in the tube 64. This also stirs the liquid in which sedimentation has occurred in the liquid flow path 32.

In each of the embodiments described above, it is assumed that the pressure in each of the gas containers 61a to 61d is controlled to be the increased pressure, the reduced pressure, and the atmospheric pressure by combining the control of the gas pump 62 and the control of the gas valve 63, but this is not a limitation. It is possible to adopt a configuration in which the gas pump 62 has the function of the gas valve 63, and the pressure in each of the gas containers 61a to 61d is controlled to be the increased pressure, the reduced pressure, and the atmospheric pressure by controlling the gas pump 62.

In each of the embodiments described above, the deformation section 60 that changes the cross-sectional shape of the liquid flow path 32 that is coupled to the liquid reservoir 31 and the liquid ejection unit 21 is exemplified, but this is not a limitation. The liquid ejection apparatus 1 may include a return flow path for returning the liquid in the liquid ejection unit 21 to the liquid reservoir 31, and may include the deformation section 60 that changes a cross-sectional shape of the return flow path. This also stirs the liquid in which sedimentation has occurred.

In each of the embodiments described above, the example in which the number of repetitions of the control pattern is adjusted in order to adjust the degree of stirring of the liquid in which sedimentation has occurred is described, but this is not a limitation. In order to adjust the degree of stirring of the liquid in which sedimentation has occurred, the speed of changing the cross-sectional shape of the liquid flow path 32 may be adjusted. Alternatively, it is possible to repeat changing a level of the increased pressure to a plurality of levels, or to repeat changing a level of the reduced pressure to a plurality of levels. Alternatively, the examples of the adjustment described above may be combined with each other.

In each of the embodiments described above, it is desirable that the direction of the pressure for changing the cross-sectional shape of the liquid flow path 32a includes a component in the buoyancy direction against the direction of gravitational force. Thus, it is possible to effectively float the liquid in which sedimentation has occurred in the liquid flow path 32a, which is effective for stirring the liquid in which sedimentation has occurred.

The control of PATTERNS 6 to 10 may be applied to the configuration of the gas container 61c shown in the third embodiment described above. This also stirs the liquid in which sedimentation has occurred in the liquid flow path 32.

What is claimed is:

1. A liquid ejection apparatus comprising:
a liquid reservoir configured to store a liquid;
a liquid ejection unit configured to eject the liquid;
a liquid flow path configured to supply the liquid from the liquid reservoir to the liquid ejection unit; and
a deformation section including a gas container configured to change a cross-sectional shape of the liquid flow path.

2. The liquid ejection apparatus according to claim 1, wherein
the deformation section includes
the gas container disposed at an outer surface of the liquid flow path, and
a pressure controller configured to control pressure of the gas container, and
the deformation section changes the cross-sectional shape of the liquid flow path by forming spaces different in internal pressure inside the gas container.

3. The liquid ejection apparatus according to claim 2, wherein
the gas container includes
a controlled container, the pressure of which is controlled by the pressure controller, and
an uncontrolled container, the pressure of which is not controlled by the pressure controller.

4. The liquid ejection apparatus according to claim 2, wherein
the gas container includes a first gas container and a second gas container,
the liquid flow path is sandwiched between the first gas container and the second gas container, and
the pressure controller is configured to control pressure in the first gas container and pressure in the second gas container.

5. The liquid ejection apparatus according to claim 4, wherein
when the pressure controller controls the pressure in the first gas container to a first pressure, the pressure controller controls the pressure in the second gas container to the first pressure.

6. The liquid ejection apparatus according to claim 5, wherein
the gas container includes a third gas container disposed at a position different from positions of the first gas container and the second gas container, and
the pressure controller is configured to
control pressure in the third gas container,
control the pressure in the third gas container to a second pressure different from the first pressure when controlling the pressure in the first gas container to the first pressure, and
control the pressure in the first gas container to the second pressure when controlling the pressure in the third gas container to the first pressure.

7. The liquid ejection apparatus according to claim 6, wherein
the second pressure is atmospheric pressure.

8. The liquid ejection apparatus according to claim 2, wherein
the cross-sectional shape of the liquid flow path is a circular shape,
the gas container includes a partition wall configured to partition a space in the gas container into a plurality of regions, and
the partition wall supports the liquid flow path.

9. The liquid ejection apparatus according to claim 8, wherein
the gas container includes a first gas container, a second gas container, and a third gas container which are partitioned by the partition wall,
the liquid flow path is filled with the liquid at pressure lower than the first pressure in a state where pressure in the first gas container is controlled to the first pressure, and
the pressure controller is configured to control pressure in the second gas container and pressure in the third gas container to the second pressure lower than the first pressure when controlling the pressure in the first gas container to the first pressure,
control the pressure in the first gas container and the pressure in the third gas container to the second pressure when controlling the pressure in the second gas container to the first pressure, and
control the pressure in the first gas container and the pressure in the second gas container to the second pressure when controlling the pressure in the third gas container to the first pressure.

10. The liquid ejection apparatus according to claim 9, wherein
the second pressure is atmospheric pressure.

11. The liquid ejection apparatus according to claim 2, wherein
the liquid flow path and the gas container are disposed in one tube.

12. The liquid ejection apparatus according to claim 11, comprising
a plurality of the tubes.
